(19) United States
(12) Patent Application Publication
(10) Pub. No.: US 2015/0136907 A1
(43) Pub. Date: May 21, 2015

(54) Deployable barrier arrangement for selectively blocking a passage in an aircraft cabin

(71) Applicant: Airbus Operations GmbH, Hamburg (DE)

(72) Inventor: Michael Lau, Hamburg (DE)

(21) Appl. No.: 14/538,437

(22) Filed: Nov. 11, 2014

(30) Foreign Application Priority Data
Nov. 19, 2013 (EP) 13193462.2

(51) Int. Cl. B64D 11/00; B64C 1/14; E06B 7/28

(52) U.S. Cl. CPC B64D 11/0023; E06B 7/28; B64C 1/1423
USPC 244/129.4

(57) ABSTRACT

A deployable barrier arrangement for selectively blocking a passage in an aircraft cabin, wherein the barrier arrangement comprises a substantially longitudinal barrier member and a joint unit for fixing the barrier member to an inner wall of the aircraft cabin. The joint unit is configured to allow for a movement of the barrier member between a stowed position in which the barrier member extends substantially parallel to the inner wall of the aircraft cabin and a deployed position in which the barrier member extends at an angle of approximately 60° to 120° to the inner wall of the aircraft cabin. The joint unit is further configured to allow for a rotational movement of the barrier member about a longitudinal axis of the barrier member.

### CROSS-REFERENCES TO RELATED APPLICATIONS

This application claims the benefit of the European patent application No. 13 193 462.2 filed on Nov. 19, 2013, the entire disclosures of which are incorporated herein by way of reference.

### BACKGROUND OF THE INVENTION

The present invention relates to a deployable barrier arrangement for selectively blocking a passage in an aircraft cabin. Further, the invention relates to an aircraft cabin area equipped with a deployable barrier arrangement of this kind.

Barrier arrangements of the this type are typically used to temporarily block passages in an aircraft cabin, so that passengers and/or movable items such as trolleys do not pass the barrier arrangement. In this context, the term “passage” generally refers to a cross-sectional area of the aircraft cabin which is otherwise free to enter and pass. A blocking of such a passage may for example be desired during take-off or landing or during unstable flight conditions. In particular, the barrier arrangements may be used to block a passage to or within a staircase of an aircraft. Such staircases may for example be provided for connecting different floor levels of the aircraft cabin.

Barrier arrangements of known types comprise joint units to which a barrier member is attached. The barrier member can typically be moved relative to the joint unit in a pivoting motion to change between a deployed and stowed position. When arranged in its deployed position, an effective blocking of an associated passage in the aircraft cabin by the barrier member is desired. To the contrary, when arranged in its stowed position, it is desired that the barrier member interferes with the passing of passengers and movable items through the passage as little as possible.

To solve these conflicting goals, in the known barrier arrangements extendible kinematic sub-structures of the barrier member are provided to adjust the barrier member's dimensions according to its present position. For example, the kinematic sub-structure is made to extend in the deployed position of the barrier member, whereas in the stowed position the kinematic sub-structure is made to retract. The effective dimensions with which the barrier member extends in the passage can thus be selectively enlarged in the deployed position, whereas in the stowed position, the barrier member's dimensions can be reduced.

These solutions, however, require a large amount of handling operations to be carried out by an operator. Furthermore, the kinematic sub-structures are generally maintenance-intensive and introduce additional error sources into the barrier arrangement.

### SUMMARY OF THE INVENTION

Accordingly, the invention is directed at an object of providing a deployable barrier arrangement of the above-mentioned type which is easy to operate and highly reliable.

This object is achieved by a deployable barrier arrangement which comprises a substantially longitudinal barrier member and a joint unit for fixing the barrier member to an inner wall of the aircraft cabin. The joint unit is configured to allow for a movement of the barrier member between a stowed position in which the barrier member extends substantially parallel to the inner wall of the aircraft cabin and a deployed position in which the barrier member extends at an angle of approximately 60° to 120° to the inner wall of the aircraft cabin. In a highly preferred embodiment, however, the barrier member extends at angle of approximately 90° to the inner wall or, in other words, is arranged substantially perpendicular to the inner wall in its deployed position.

The joint unit is further configured to allow for a rotational movement of the barrier member about a longitudinal axis of the barrier member. Compared to the barrier arrangements of known types, the barrier arrangement according to the invention thus is provided with an additional rotational degree of freedom. This may be used for rotating the barrier member about the longitudinal axis by different amounts relative to the joint unit when changing between the stowed and the deployed position. For example, in the deployed position, the barrier member can be oriented such that a section of increased lateral extension of the barrier member extends within the passage (i.e., extends within a cross-sectional area of the aircraft cabin as defined by the passage). In the stowed position, to the contrary, the barrier member can be oriented such that the section of increased lateral extension extends at an angle to the passage, for example by extending parallel to the inner wall. In this way, the effective dimensions of the barrier member with which it extends in the passage can be selectively enlarged and reduced when changing between the deployed and stowed positions.

It will be understood, that the longitudinal axis of the barrier member about which a rotation can be carried out may be formed by any axis extending in a substantially longitudinal direction of the barrier member. Therefore, the longitudinal axis may not necessarily run through the geometric center or center of gravity of the barrier member. As will be further discussed below, the exact position of this longitudinal axis may instead be defined by the specific type of rotational joint or link within the joint unit to which the barrier member is attached.

In a preferred embodiment, the joint unit is configured to allow for a simultaneous rotation of the barrier member about the longitudinal axis when moving the barrier member between the stowed and deployed position. Such a simultaneous rotation increases the ease of use when handling the barrier member and thus the operability of the barrier arrangement.

In another preferred embodiment, the joint unit comprises at least one multiple axis pivot joint which is connected to the barrier member. The multiple axis pivot joint may define at least two rotational axes allowing for the rotation of the barrier member between its stowed and its deployed position as well as the rotation of the barrier member about the longitudinal axis. The multiple axis pivot-joint may be provided, for example, in form of a universal joint, a ball-and-socket joint, a cardan joint or the like. In a highly preferred embodiment, only one multiple axis pivot-joint is provided and forms the only joint/link within the barrier arrangement. This reduces the amount of required maintenance work and limits potential error sources.

The joint unit may further comprise a tilted guide surface. The barrier member may comprise a complementary tilted contact surface. The contact surface of the barrier member and the guide surface of the joint unit may bear against each other. Typically, the guide surface may be tilted such that it defines a plane which extends at an angle to the inner wall of the aircraft cabin. For example, the guide surface may be tilted about numerous spatial axes, for example about both spatial axes of a plane extending in parallel to the inner wall and also about the normal axis of this plane.

In this connection, the guide surface may be tilted and adapted to interact with the contact surface in such a way that the barrier member is forcibly guided for carrying out a rotation about the longitudinal axis when being moved between the stowed and deployed position. According to this embodiment, the barrier arrangement allows for a rotation of the barrier member about the longitudinal axis during the respective movement without requiring any additional dedicated handling operations by an operator. This increases the ease of use of the barrier arrangement and ensures an optimal relative positioning of barrier member and joint unit during any stage of movement and/or positioning of the barrier arrangement.

The joint unit may further be configured to limit the rotational movement about the barrier member's longitudinal axis to an amount of 90°. Such a limitation may for example be achieved by providing mechanical stop members within the joint unit and is effective for avoiding operating errors such as collisions of the barrier member with surrounding elements of the aircraft cabin.

Likewise, the joint unit may be configured to limit the rotational movement of the barrier member such that it cannot be moved to past the stowed and/or deployed position. This similarly ensures a safe operation of the barrier arrangement and helps to avoid undesired collisions or interferences of the barrier member with the aircraft cabin's interior.

In a preferred embodiment, the barrier arrangement further comprises a separate stop member which is configured to act as a mechanical stop when the barrier member is moved to its deployed position. The stop member may, for example, be configured to be fixed to a further inner wall extending at a distance from and facing the inner wall at which the joint unit is positioned. In general, such a stop member may be provided as an alternative or additional means to limit the movement of the barrier member to a range between the stowed and deployed position compared to the above-mentioned limitation through the joint unit itself.

In this connection, the stop member may be provided with a receiving section configured to receive a tip end section of the barrier member when the barrier member is moved to its deployed position. The receiving section may be shaped complementary to the tip end section of the barrier member, i.e., be provided with a section having a negative shape of the tip end section. With the aid of such a receiving section, a stable positioning of the barrier member in the deployed position can be achieved. The receiving section may at least in part be elastically deformable in order to form a locking/snap-in connection upon receiving the tip end section of the barrier member.

The barrier arrangement may further comprise a separate holder member which is configured to hold the barrier member in the stowed position. Said holder member may for example be arranged at the same inner wall of the aircraft cabin to which the joint unit is fixed.

In this connection, the holder member may substantially be shaped as a bracket which is configured to receive the barrier member and form of a locking connection therewith. For doing so, the holder member may at least in part be elastically deformable so that the barrier member can snap into the holder member, thus forming the locking connection.

In a preferred embodiment, the barrier arrangement may further comprise a sub-barrier section which is configured to extend substantially parallel to the inner wall of the aircraft cabin when the barrier member is in its stowed position and which is configured to extend at an angle of approximately 60° to 120° to the inner wall of the aircraft cabin when the barrier member in its deployed position. The sub-barrier section may be connected to the barrier member and may generally be provided to define a section of increased lateral extension of the barrier member relative to the longitudinal axis. As indicated above, the barrier member's orientation may thus be selectively adapted so that the sub-barrier section extends within the passage or at an angle thereto by making use of the additionally provided rotational degree of freedom of the barrier member.

In this connection, the sub-barrier section may be formed integrally with the barrier member and may in particular comprise at least one first section extending laterally to the barrier member's longitudinal axis and at least one second section extending parallel to the barrier member's longitudinal axis. The first and the second section are connected to each other. By forming the sub-barrier section and the barrier member as an integral unit, the reliability of the barrier arrangement is greatly increased, since no additional joints, links or other kinematic structures need to be provided apart from the joint unit. The first section of the sub-barrier section may generally be provided to space the second section away from the barrier member in a lateral direction. The first and the second section of the sub-barrier section may be arranged at the barrier member to define an L- or T-profile or, if two first sections are provided, a C-profile. In the latter case, the C-profile may be attached to the barrier member with its two end faces such that the barrier member closes the open shape/side of the C-profile. In general, the barrier member and the sub-barrier section may be connected to each other by welding or gluing or by mechanical fastening means. Alternatively, they may be formed as a one-piece element by casting or molding.

The invention furthermore relates to an aircraft cabin area. The aircraft cabin area comprises an inner, preferably vertical wall extending between a floor area and a ceiling area of the aircraft cabin area. A further inner, preferably vertical wall of the aircraft cabin area extends between the floor area and the ceiling area and faces the inner wall. Finally, the aircraft cabin area comprises a deployable barrier arrangement according to any of the previously discussed aspects for selectively blocking a passage in the aircraft cabin area. The passage may in particular lead to or be arranged within a staircase. The barrier arrangement thus may serve to effectively block the passage to or within the staircase to avoid passengers or movable items to enter or pass through the staircase.

In this connection, the sub-barrier section of the barrier arrangement, in the deployed position of the barrier member, may extend towards the floor area. The first section of the sub-barrier section may extend substantially perpendicular to the floor area. Such configuration of the sub-barrier section achieves to effectively increase the dimensions with which the barrier member extends in the passage when arranged in its deployed position, thus preventing, for example, children from passing the barrier arrangement below the barrier member.

### BRIEF DESCRIPTION OF THE DRAWINGS

Preferred embodiments of the invention will now be described in greater detail with reference to the appended drawings, wherein

FIG. 1 shows a perspective view of an aircraft cabin area equipped with a deployable barrier arrangement, wherein the barrier arrangement is installed at an entrance to a staircase and the barrier member is arranged in its stowed position;

FIG. 2 shows a top view of the barrier arrangement according to FIG. 1;

FIG. 3 shows the aircraft cabin area and the barrier arrangement according to FIG. 1 with the barrier member being arranged in its deployed position;

FIG. 4 shows a top view of the barrier arrangement according to FIG. 3; and

FIG. 5 shows a detailed view of the joint unit of the barrier arrangement according to the previous figures.

### DETAILED DESCRIPTION OF THE PREFERRED EMBODIMENTS

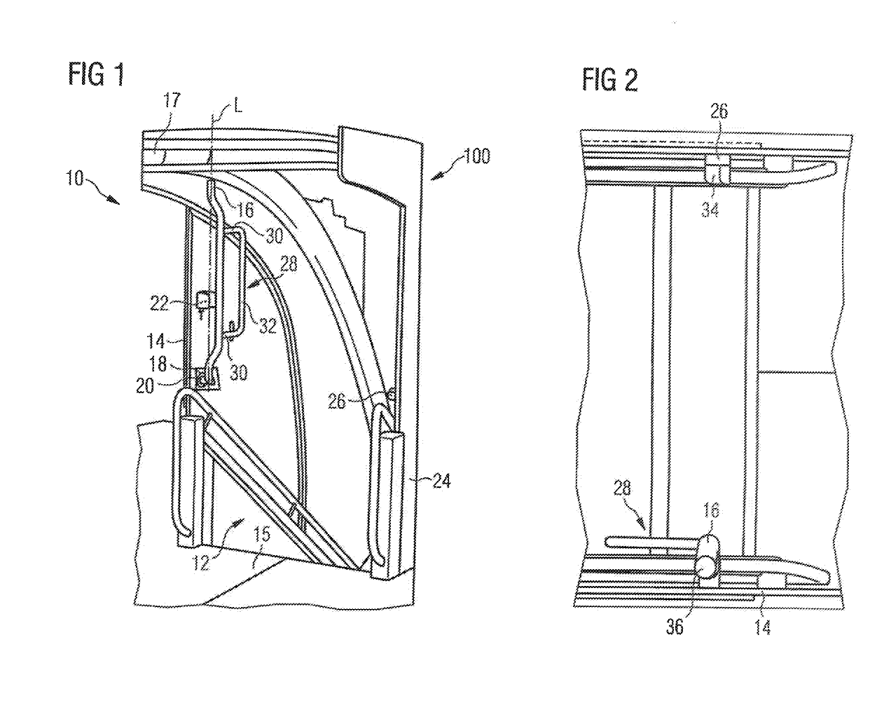

FIG. 1 shows a perspective view of an aircraft cabin area 100 equipped with a deployable barrier arrangement 10. The barrier arrangement 10 depicted in FIG. 1 is located at an entrance to a staircase 12 and fixed to an inner vertical sidewall 14 of the aircraft cabin. The inner vertical sidewall 14 generally extends between a floor area 15 and a ceiling area 17 of the aircraft cabin. The barrier arrangement 10 comprises a longitudinal barrier member 16 which is connected to a joint unit 18 by a multiple axis pivot joint 20. The joint unit 18 is fixed to the vertical side wall 14 by mechanical means and, as will be described in further detail below, allows for a pivoting motion of the barrier member 16 between a stowed and deployed position as well as for a rotational movement of the barrier member about a longitudinal axis L of the barrier member 16.

The barrier arrangement of FIG. 1 furthermore comprises a separate holder member 22 which is arranged at the vertical sidewall 14 and is spaced apart from the joint unit 18 such that it can receive a section of the barrier member 16. The holder member 22 is generally shaped as a bracket and comprises an elastic section, so that it can form a locking/snap-in connection with the barrier member 16. In FIG. 1, the barrier member 16 is depicted in a non-engaged state with the holder member 22 for illustrative purposes only, in order to indicate the bracket shape of the holder member 22. However, according to the depicted embodiment, it is generally contemplated that the barrier member 16 engages with the holder member 22 in the stowed position.

Furthermore, at a further inner vertical sidewall 24 being located opposite to the inner vertical sidewall 14 and facing the inner vertical sidewall 14, a stop member 26 is provided and located approximately at the same height level as the joint unit 18.

The longitudinal barrier member 16 is connected to a sub-barrier section 28 which comprises two first sections 30 extending laterally to the longitudinal axis L of the barrier member 16 as well as a second section 32 extending parallel to the longitudinal axis L. In the shown embodiment, the first and second sections 30, 32 are arranged to form a substantially C-shaped profile which is connected to the barrier member 16 such that the latter closes the open side of the C-shaped profile. The barrier member 16 and the sub-barrier section 28 are generally formed as a one-piece integral unit. As further obvious from FIG. 1, the sub-barrier section 28 defines a substantially planar section of increased lateral extension of the barrier member 16.

In FIG. 1, the barrier member 16 is arranged in its stowed position. In this position, the barrier member 16 substantially extends in parallel to the vertical sidewall 14. The same applies to the sub-barrier section 28 respectively to the section of increased lateral extension as defined by its C-shaped profile. Therefore, the barrier member 16 does hardly extend within the passage and thus does not interfere with a free passing thereof.

FIG. 2 shows a top view of the barrier arrangement of FIG. 1. As obvious from this figure, the stop member 16 comprises a receiving section 34 which is shaped complementary to a tip end section 36 of the longitudinal barrier member 16. Therefore, the receiving section 34 can receive the tip end section 36 in a positively locking manner and stabilize and hold the barrier member 16 in its deployed position.

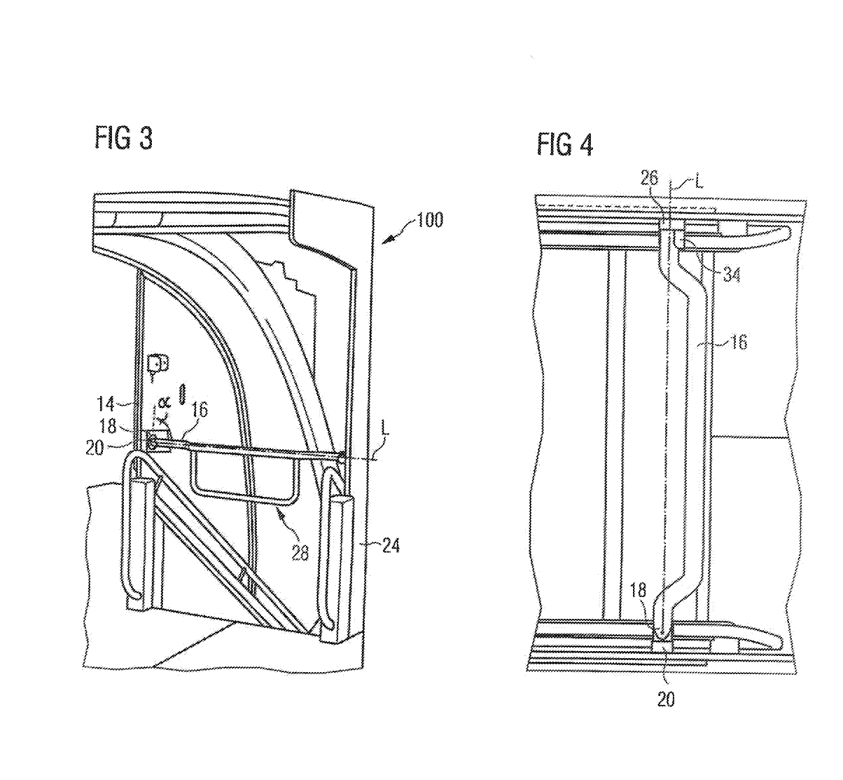

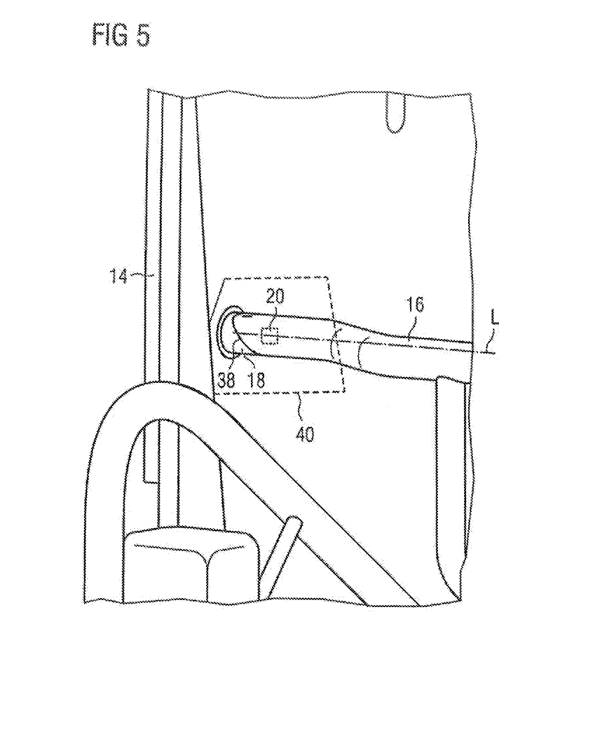

In FIGS. 3 and 4, the barrier arrangement according to the previous figures is shown with the barrier member 16 being arranged in its deployed position. In this position, the barrier member 16 extends substantially horizontally from the joint unit 18 towards the further vertical side wall 24. There it is received in the receiving section 34 of stop member 26. The barrier member 16 thus extends in an angle α of 90° to the vertical sidewalls 14, 24 and extends over the complete width of the staircase 12. As a result, the entrance to the staircase 12 is effectively blocked. For moving the barrier member 16 between the stowed and deployed position, the barrier member 16 is manually pivoted about the joint unit 18 by means of the multiple-axis pivot joint 20.

From FIGS. 3 and 4, it is furthermore shown that the sub-barrier section 28, respectively the section of increased lateral extension defined by the C-shaped profile, does equally extend at an angle α of 90° to the vertical side wall 14. This is achieved by rotating the unit of barrier member 16 and sub-barrier section 28 simultaneously about the longitudinal axis L by an amount of 90° L of when moving the barrier member from the stowed position to the deployed position.

In FIG. 5, the joint unit 18 is depicted in detail. As can be seen from this figure, the joint surface 18 is provided with a tilted guide surface 38 which extends at an angle to the vertical side wall 14. The end section of the barrier member 16 opposite to the joint unit 18 is provided with a contact surface 40 which is tilted complementary to the guide surface 38. The schematically illustrated multiple axis pivot joint 20 is arranged between the joint unit 18 and barrier member 16 such it connects the barrier member 16 and the joint unit 18 and such that the guide surface 38 and the contact surface 40 bear against each other. Accordingly, the multiple axis pivot joint 20, respectively the relative position of the barrier member 16 and the multiple axis pivot joint 20 define the position of the longitudinal axis L of the barrier member 16 about which a rotation of the same can be carried out.

The contact surface 40 is tilted in such a way that the barrier member 16 is forcibly guided for a rotation about its longitudinal axis L by 90° when being moved between the stowed and deployed position. In this connection, the direction of rotation points out of the image plane of FIGS. 3 and 4 when moved to the deployed position and accordingly points into the image planes when moved to the stowed position. Therefore, when changing the position of the barrier member 16 between the stowed and deployed positions according to FIGS. 1 and 3, a rotation of the unit comprising the barrier member 16 and the sub-barrier section 28 by 90° is achieved without any dedicated additional handling operations by an operator. Thus, by providing the tilted guide surface 40, an optimal orientation of the barrier member 16 and the sub-barrier section 28 in the stowed as well as in the deployed position is ensured.

As is apparent from the foregoing specification, the invention is susceptible of being embodied with various alterations and modifications which may differ particularly from those that have been described in the preceding specification and description. It should be understood that I wish to embody within the scope of the patent warranted hereon all such modifications as reasonably and properly come within the scope of my contribution to the art.

1. A deployable barrier arrangement for selectively blocking a passage in an aircraft cabin, the barrier arrangement comprising:
a substantially longitudinal barrier member, and
a joint unit for fixing the barrier member to an inner wall of the aircraft cabin,
the joint unit being configured to allow for a movement of the barrier member between a stowed position in which the barrier member extends substantially parallel to the inner wall of the aircraft cabin and a deployed position in which the barrier member extends at an angle of approximately 60° to 120° to the inner wall of the aircraft cabin, and
the joint unit being further configured to allow for a rotational movement of the barrier member about a longitudinal axis of the barrier member.

2. The deployable barrier arrangement according to claim 1, wherein the joint unit is configured to allow for a simultaneous rotation of the barrier member about the longitudinal axis when the barrier member is moved between the stowed and deployed position.

3. The deployable barrier arrangement according to claim 1, wherein the joint unit comprises at least one multiple axis pivot joint which is connected to the barrier member, wherein the multiple axis pivot joint defines at least two rotational axes allowing for the rotation of the barrier member between its stowed and its deployed position, as well as the rotation of the barrier member about the longitudinal axis.

4. The deployable barrier arrangement according to claim 1, wherein the joint unit comprises a tilted guide surface and the barrier member comprises a complementary tilted contact surface, wherein the contact surface of the barrier member and the guide surface of the joint unit bear against each other.

5. The deployable barrier arrangement according to claim 4, wherein the guide surface is tilted and adapted to interact with the contact surface in such a way that the barrier member is forcibly guided for carrying out a rotation about the longitudinal axis while being moved between the stowed and deployed position.

6. The deployable barrier arrangement according to claim 1, wherein the joint unit is configured to limit the rotational movement about the barrier member's longitudinal axis to an angle of 90°.

7. The deployable barrier arrangement according to claim 1, wherein the joint unit is configured to limit the movement of the barrier member such that it cannot be moved past at least one of the stowed and the deployed position.

8. The deployable barrier arrangement according to claim 1, wherein the barrier arrangement further comprises a separate stop member which is configured to be fixed to a further inner wall facing the inner wall and which further is configured to act as a mechanical stop when the barrier member is moved to its deployed position.

9. The deployable barrier arrangement according to claim 8, wherein the stop member is provided with a receiving section configured to receive a tip end section of the barrier member when the barrier member is moved to its deployed position.

10. The deployable barrier arrangement according to claim 1, wherein the barrier arrangement further comprises a separate holder member configured to be fixed to the inner wall and which further is configured to hold the barrier member in the stowed position

11. The deployable barrier arrangement according to claim 10, wherein the holder member is substantially shaped as a bracket configured to receive the barrier member and form a locking connection therewith.

12. The deployable barrier arrangement according to claim 1, wherein the barrier arrangement further comprises a sub-barrier section extending substantially parallel to the inner wall of the aircraft cabin when the barrier member is in its stowed position and extending at an angle of approximately 60° to 120° to the inner wall of the aircraft cabin when the barrier member in its deployed position, the sub-barrier section being connected to the barrier member.

13. The deployable barrier arrangement according to claim 12, wherein the sub-barrier section is formed integrally with the barrier member and comprises at least one first section extending laterally to the barrier member's longitudinal axis and at least one second section extending parallel to the barrier member's longitudinal axis, wherein the first and the second sections are connected to each other.

14. An aircraft cabin area comprising:
an inner wall extending between a floor area and ceiling area of the aircraft cabin area,
a further inner wall extending between the floor area and the ceiling area of the aircraft cabin area and facing the inner wall, and
a deployable barrier arrangement for selectively blocking a passage in the aircraft cabin area, the passage leading to or being arranged within a staircase, the barrier arrangement comprising:
a substantially longitudinal barrier member, and
a joint unit for fixing the barrier member to an inner wall of the aircraft cabin,
the joint unit being configured to allow for a movement of the barrier member between a stowed position in which the barrier member extends substantially parallel to the inner wall of the aircraft cabin and a deployed position in which the barrier member extends at an angle of approximately 60° to 120° to the inner wall of the aircraft cabin, and
the joint unit being further configured to allow for a rotational movement of the barrier member about a longitudinal axis of the barrier member.

15. The aircraft cabin area according to claim 14, wherein the sub-barrier section of the barrier arrangement, in the deployed position of the barrier member, extends from the barrier member towards the floor area, the first section of the sub-barrier section extending substantially perpendicular to the floor area.
